(19) United States
(12) Patent Application Publication
(10) Pub. No.: US 2008/0122650 A1
(43) Pub. Date: May 29, 2008

(54) Radio transmission system, remote control apparatus, electronic instrument and radio transmission method

(76) Inventor: Norio Shimo, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/975,892

(22) Filed: Oct. 22, 2007

(30) Foreign Application Priority Data
Nov. 24, 2006 (JP) JP 2006-317649

(51) Int. Cl. G08C 19/00

(52) U.S. Cl. 340/825.72

(57) ABSTRACT

A radio transmission system includes a remote control apparatus; and an electronic instrument configured to carry out radio transmissions with and remotely controlled by the remote control apparatus. The remote control apparatus includes a remote control signal sending section, and a reflected signal sending section. The electronic instrument includes a remote control signal receiving section, a reflected signal receiving section, and a control section.

### CROSS REFERENCES TO RELATED APPLICATIONS

The present invention contains subject matter related to Japanese Patent Application JP 2006-317649 filed with the Japan Patent Office on Nov. 24, 2006, the entire contents of which being incorporated herein by reference.

### BACKGROUND OF THE INVENTION

1. Field of the Invention

The present invention relates to a radio transmission system for transmitting data at a high speed, a remote control apparatus, an electronic instrument and a radio transmission method.

2. Description of the Related Art

In recent years, electronic apparatus such as PCs (Personal Computers) and digital cameras have been becoming popular, making it necessary to transmit data from a transmitter to a receiver at a home at a high speed. As a method for transmitting data from a transmitter to a receiver at a home, construction of a radio network conforming to the IEEE (Institute of Electrical and Electronic Engineers) 802.11 standard or the like is conceivable. In this case, however, there are many problems and restrictions in the wire transmission of data. The problems and restrictions include poor capabilities demonstrated by waves as capabilities of propagating over long distances, errors generated during transmissions of data and effective utilization of a limited number of frequencies. In addition, the problems and restrictions also include the fact that, in the radio network conforming to the IEEE 802.11 standard or the like, the amount of electric power consumed in a standby state or the like is large like ordinary home electrical appliances because signals are exchanged between communication partners in both directions. On top of that, the problems and restrictions also include the fact that the cost of such a transmission system is high.

Thus, systems for carrying out communications in one direction and applications for such systems are each desired respectively as a system and an application, which will solve the problems caused by the complexity and cost of a system for carrying out communications in both directions.

An example of the communication carried out in one direction is a communication carried out by a remote controller by making use of an infrared ray. The remote controller is established as an input commander for carrying out a radio communication to transmit a command to an electronic instrument in one direction. Remote controllers are used as accessories for a number of home electrical appliances because the remote controllers can be manufactured at a low cost and are easy to maintain by for example merely replacing batteries of the controllers. However, it is difficult to make the remote controller capable of carrying out communications in both directions at a low power consumption. In addition, it is also hard to add an expensive and complicated application or a communication section to an existing system.

On top of that, for example, in the case of IrDA (Infrared Data Association) known as a communication method making use of an infrared ray, the distance over which data can be transmitted is about 1 m, which is regarded as a value of a short transmission distance a whereas the transmission rate is also not so high either. It is difficult to transmit data having a large amount to a home electrical appliance by carrying out a radio communication making use of a remote controller or the like.

### SUMMARY OF THE INVENTION

Microwaves of an extremely high frequency (hereinafter referred to as EHF) having a frequency approximately in the range 3 to 300 GHz or a wavelength in the range 100 to 1 mm are suitable for radio communications among home electrical appliances in a house as shown in FIG. 8. However, such Microwaves of the EHF have a strong forward-propagation characteristic and are not so proof against barriers set by obstacles. Thus, in a radio communication system making use of such EHF, a section configured to avoid barriers set by obstacles is demanded. Examples of such a section include a section configured to control and/or adjust a directivity characteristic.

For example, in accordance with a technology disclosed in Japanese Patent Laid-open No. 2005-244362, hereinafter referred to as Patent Document 1, an EHF sending apparatus irradiates a laser beam to an EHF reflection plate. Then, by adjusting the angle of the orientation of the EHF reflection plate, it is possible to avoid barriers set by obstacles. In addition, in accordance with a technology disclosed in Japanese Patent Laid-open No. 2005-252819, hereinafter referred to as Patent Document 2, the directivity direction of an antenna is rotated on the basis of a result of detecting a warning signal, which is sent as an EHF band signal, in order to adjust the directivity characteristic of the antenna with a higher degree of reliability and at a higher speed.

In accordance with the technologies disclosed in Patent Documents 1 and 2, however, in a process to send an EHF band signal, much electric power is undesirably consumed. It is thus difficult to apply the technologies to a remote controller, which is demanded to consume with little electric power.

Japanese Patent Laid-open No. 2005-333169 discloses a radio transmission technology adopting a backscatter method intended for reducing the power consumption. In accordance with this technology, however, a data sending side may not be capable of receiving an unmodulated carrier signal from a data receiving side in some cases due to a condition of the data sending side.

Addressing the problems described above, the present invention has been proposed as an invention providing a radio transmission system capable of transmitting data of a large amount, a remote control apparatus, an electronic instrument and a radio transmission method.

In order to solve the problems described above, an embodiment of the present invention provides a radio transmission system, including: a remote control apparatus; and an electronic instrument configured to carry out radio transmissions with and remotely controlled by the remote control apparatus. The remote control apparatus includes a remote control signal sending section configured to send a remote control signal to the electronic instrument, and a reflected signal sending section configured to receive a microwave unmodulated carrier signal in an extremely high frequency band from the electronic instrument after or during sending of a remote control signal and modulate and send the unmodulated carrier signal as a reflected signal to the electronic instrument. The electronic instrument includes a remote control signal receiving section configured to receive a remote control signal from the remote control apparatus, a reflected signal receiving section configured to send a microwave unmodulated carrier signal in an extremely high frequency band to the remote control apparatus and receive a reflected signal modulated from the unmodulated carrier signal from the remote control apparatus, and a control section configured to control determination as to whether or not the unmodulated carrier signal should be sent to the remote control apparatus in response to a state of reception of the remote control signal.

In addition, a remote control apparatus, includes: a remote control signal sending section configured to send a remote control signal; and a reflected signal sending section configured to receive a microwave unmodulated carrier signal in an extremely high frequency band after or during sending of the remote control signal and modulate and send the carrier signal as a reflected signal.

In addition, an electronic instrument, includes: a remote control signal receiving section configured to receive a remote control signal; a reflected signal receiving section configured to send a microwave unmodulated carrier signal in an extremely high frequency band and receive a reflected signal modulated from the unmodulated carrier signal; and a control section configured to control determination as to whether or not the unmodulated carrier signal should be sent in response to a state of reception of the remote control signal.

In addition, the embodiment of the present invention provides a radio transmission method for carrying out radio transmissions between a remote control apparatus and an electronic instrument which is remotely controlled by the remote control apparatus, the radio transmission method including the steps of: receiving a remote control signal, sending an unmodulated carrier, sending a reflected signal, and demodulating a reflected signal. The remote control signal receiving step, carried out by the electronic instrument, receives a remote control signal sent from the remote control apparatus. The unmodulated carrier sending step, carried out by the electronic instrument, sends a microwave unmodulated carrier signal in an extremely high frequency band in response to a state of reception of the remote control signal received at the remote control signal receiving step. The reflected signal sending step, executed by the remote control apparatus, receives the unmodulated carrier signal sent at the modulated carrier sending signal and modulates and sends the unmodulated carrier signal as a reflected signal to the electronic instrument. The reflected signal demodulating step, carried out by the electronic instrument, receives and demodulates the reflected signal sent from the remote control apparatus at the reflected signal sending step.

As described above, in accordance with an embodiment of the present invention, the electronic instrument sends an unmodulated carrier signal having a frequency in an EHF or microwave band to the remote control apparatus in accordance with the state of reception of a remote control signal received from the remote control apparatus. Thus, the remote control apparatus is capable of transmitting data having a large amount to the electronic instrument with a high degree of reliability.

### BRIEF DESCRIPTION OF THE DRAWINGS

FIG. 1 is a block diagram roughly showing a typical configuration of a radio transmission system according to an embodiment of the present invention;

FIG. 2 is a block diagram showing concrete configurations of a reflected signal sending module and a reflected signal receiving module;

FIGS. 3A to 3C are diagrams showing a signal flow of a reflected signal sending module and a reflected signal receiving module;

FIG. 4 is a block diagram showing a remote control system;

FIG. 5 is a diagram showing timings for sending an infrared ray signal and transmitting an EHF;

FIG. 6 is a diagram showing a typical installation layout of a light receiving section of the infrared ray signal;

FIG. 7 shows a flowchart representing operations of the remote controller system; and

FIG. 8 is a diagram showing a state of utilization of frequency bands in radio communication technologies.

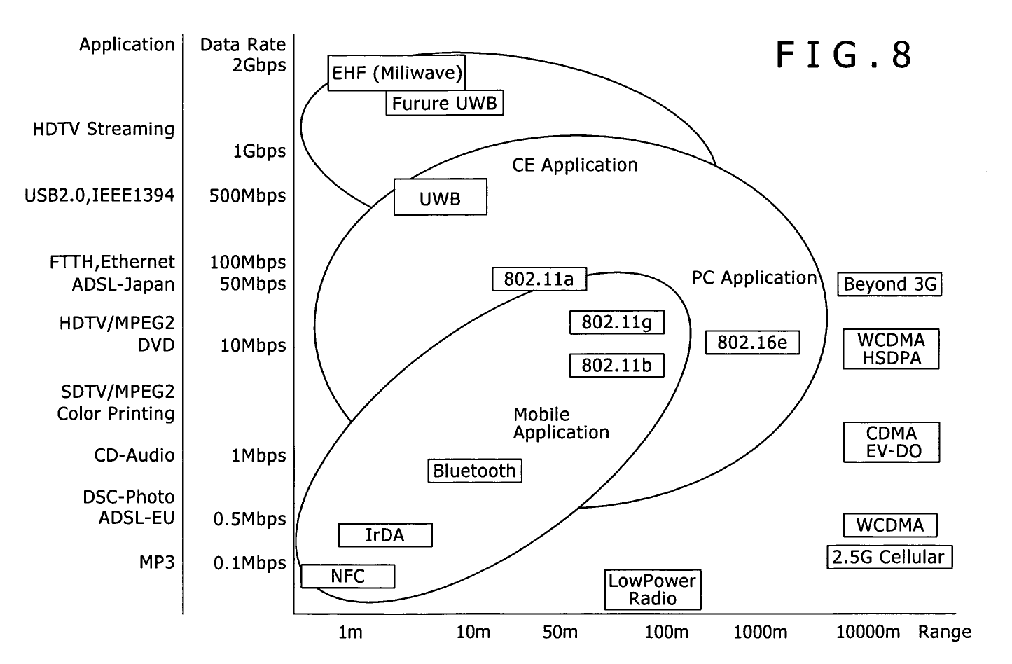

### DETAILED DESCRIPTION OF THE PREFERRED EMBODIMENT

A concrete embodiment is explained in detail by referring to drawings as follows.

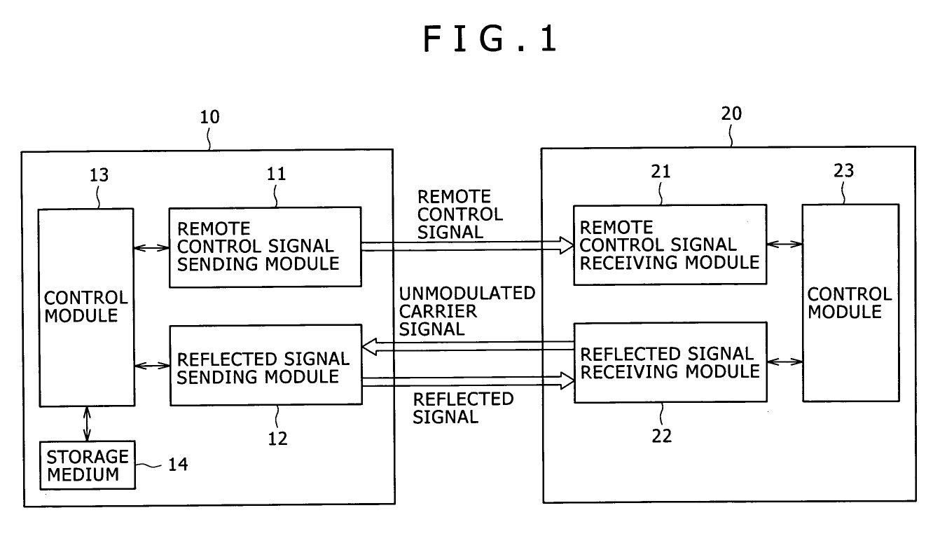

FIG. 1 is a block diagram roughly showing a typical configuration of a radio transmission system according to an embodiment of the present invention. The radio transmission system employs a remote control apparatus 10 such as a remote controller and an electronic instrument 20 such as a TV set. The remote control apparatus 10 is an apparatus for remotely controlling the electronic instrument 20.

The remote control apparatus 10 includes a remote control signal sending module 11, a reflected signal sending module 12, a control module 13 and a storage medium 14. The remote control signal sending module 11 is a module for sending a remote control signal to the electronic instrument 20. The reflected signal sending module 12 is a module for receiving an extremely high frequency (hereinafter referred to as EHF) or microwave band unmodulated carrier signal sent by the electronic instrument 20, modulating the carrier signal and sending the modulated carrier signal as a reflected signal to the electronic instrument 20. The control module 13 is a module for managing information stored in the storage medium 14 and control commands of remote control signals to be sent to the electronic instrument 20. The storage medium 14 is a memory for storing the information, which is to be sent to the electronic instrument 20.

The remote control signal sending module 11 sends a remote control signal to the electronic instrument 20. The remote control signal sent by the remote control signal sending module 11 to the electronic instrument 20 is typically an infrared ray ON/OFF pulse signal. The width of the remote control signal is several hundreds of msec. at the most.

After the remote control signal sending module 11 sends a remote control signal to the electronic instrument 20 or while the remote control signal sending module 11 is sending a remote control signal to the electronic instrument 20, the reflected signal sending module 12 may receive an EHF or microwave band unmodulated carrier signal. If the reflected signal sending module 12 receives such an unmodulated carrier signal from the electronic instrument 20 because the electronic instrument 20 has made a decision to send the unmodulated carrier signal to the remote control apparatus 10, the reflected signal sending module 12 modulates the unmodulated carrier signal in accordance with data to be sent to the electronic instrument 20 by adoption of a BPSK (Binary Phase Shift Keying) modulation technique or the like and sends a reflected signal obtained as a result of the modulation process to the electronic instrument 20. The reflected signal conveys the data sent by the remote control apparatus 10 to the electronic instrument 20.

The control module 13 manages data stored in the storage medium 14 and control commands of the electronic instrument 20. In a process carried out by the reflected signal sending module 12 to modulate an unmodulated carrier signal for example, the control module 13 reads out desired data from the storage medium 14 through an interface not shown in the figure, and supplies the data to the reflected signal sending module 12.

The storage medium 14 is typically a memory card. It is desirable to make use of a storage medium 14 that can be mounted onto the remote control apparatus 10 and dismounted from it.

The electronic instrument 20 employs a remote control signal receiving module 21, a reflected signal receiving module 22 and a control module 23. The remote control signal receiving module 21 is a module for receiving a remote control signal sent by the remote control apparatus 10. The reflected signal receiving module 22 is a module for sending an EHF or microwave band unmodulated carrier signal to the remote control apparatus 10 and receiving a reflected signal from the remote control apparatus 10. The reflected signal is a signal obtained as a result of a process carried out by the remote control apparatus 10 to modulate the unmodulated carrier signal. The control module 23 is a module for controlling the sending of the unmodulated carrier signal to the remote control apparatus 10 in accordance with a state of reception of a remote control signal received by the remote control signal receiving module 21 from the remote control apparatus 10.

The remote control signal receiving module 21 receives a remote control signal transmitted by the remote control apparatus 10. The remote control signal receiving module 21 employs a plurality of light receiving sections for receiving the remote control signal. The remote control signal receiving module 21 compares the light receiving levels of the remote control signal in the light receiving sections and supplies a result of the comparison to the control module 23.

In accordance with a command received from the control module 23, the reflected signal receiving module 22 sends an EHF or microwave band unmodulated carrier signal to the remote control apparatus 10. In addition, also in accordance with a command received from the control module 23, the reflected signal receiving module 22 receives a reflected signal from the remote control apparatus 10. As described earlier, the reflected signal is a signal obtained as a result of a process carried out by the remote control apparatus 10 to modulate the EHF or microwave band unmodulated carrier signal in accordance with data to be sent to the electronic instrument 20. Then, the reflected signal receiving module 22 demodulates the reflected signal in order to fetch the data sent by the remote control apparatus 10 from the reflected signal.

The control module 23 controls the sending of the unmodulated carrier signal to the remote control apparatus 10 in accordance with a state of reception of a remote control signal received by the remote control signal receiving module 21 from the remote control apparatus 10. To put it concretely, on the basis of the light receiving levels of a remote control signal in the light receiving sections employed in the remote control signal receiving module 21, the control module 23 produces a result of determination as to whether or not the remote control apparatus 10 is capable of receiving an EHF or microwave band unmodulated carrier signal sent by the electronic instrument 20. If the result of the determination indicates that the remote control apparatus 10 is capable of receiving an EHF or microwave band unmodulated carrier signal from the electronic instrument 20, the control module 23 issues a command to the reflected signal receiving module 22 to send an EHF or microwave band unmodulated carrier signal to the remote control apparatus 10.

In addition, it is desirable to provide the electronic instrument 20 with a determination-result reporting section for notifying the user of the result of the determination as to whether or not the remote control apparatus 10 is capable of receiving an EHF or microwave band unmodulated carrier signal sent by the electronic instrument 20. The user can thus know whether or not the remote control apparatus 10 is capable of receiving an EHF or microwave band unmodulated carrier signal.

In accordance with the radio transmission system described above, the remote control apparatus 10 sends a control command to the electronic instrument 20 with the remote control apparatus 10 kept in a posture set in a direction toward the front face of the electronic instrument 20, which the user makes an attempt to control. In such a posture, the remote control apparatus 10 is capable of transmitting data to the electronic instrument 20 by making use of an EHF or microwave band carrier signal having a strong forward-propagation characteristic.

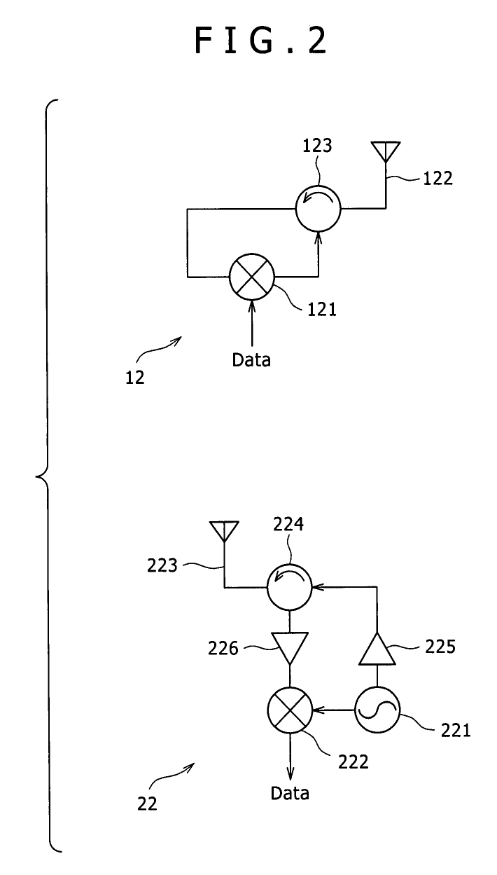

FIG. 2 is a block diagram showing concrete configurations of the reflected signal sending module 12 and the reflected signal receiving module 22. As shown in the figure, the reflected signal sending module 12 includes a modulator 121, an antenna 122 and a circulator 123. The modulator 121 is a section for modulating an EHF or microwave band unmodulated carrier signal and sending the modulated signal to the electronic instrument 20 as a reflected signal. The antenna 122 is a section for receiving the EHF or microwave band unmodulated carrier signal from the electronic instrument 20 and sending the reflected signal. The antenna 122 supplies the EHF or microwave band unmodulated carrier signal received from the electronic instrument 20 to the modulator 121 by way of the circulator 123. Conversely, the modulator 121 supplies the reflected signal to the antenna 122 by way of the circulator 123.

On the other hand, the reflected signal receiving module 22 employs an oscillator 221, a demodulator 222, an antenna 223, a circulator 224 as well as amplifiers 225 and 226. The oscillator 221 is a section for generating the aforementioned EHF or microwave band unmodulated carrier signal to be sent to the remote control apparatus 10. The oscillator 221 supplies the EHF or microwave band unmodulated carrier signal to the amplifier 225 and the demodulator 222. The demodulator 222 is a unit for demodulating the reflected signal received from the remote control apparatus 10 by making use of the unmodulated carrier signal received from the oscillator 221. The antenna 223 is a section for sending the EHF or microwave band unmodulated carrier signal to the remote control apparatus 10 and receiving the reflected signal from the remote control apparatus 10. The amplifier 225 is a section for amplifying the EHF or microwave band unmodulated carrier signal generated by the oscillator 221. The amplified unmodulated carrier signal is supplied to the antenna 223 by way of the circulator 224 to be eventually sent to the remote control apparatus 10. The reflected signal received by the antenna 223 from the remote control apparatus 10 is supplied to the amplifier 226 by way of the circulator 224. The amplifier 226 is a section for amplifying the reflected signal and supplying the amplified reflected signal to the demodulator 222.

The circulators 123 and 224 are each a three-port passive device demanding no power supply. Used for determining a forward-propagation direction in a process to send an EHF or microwave band carrier signal, the circulators 123 and 224 are widely applied to radar and radio-communication fields.

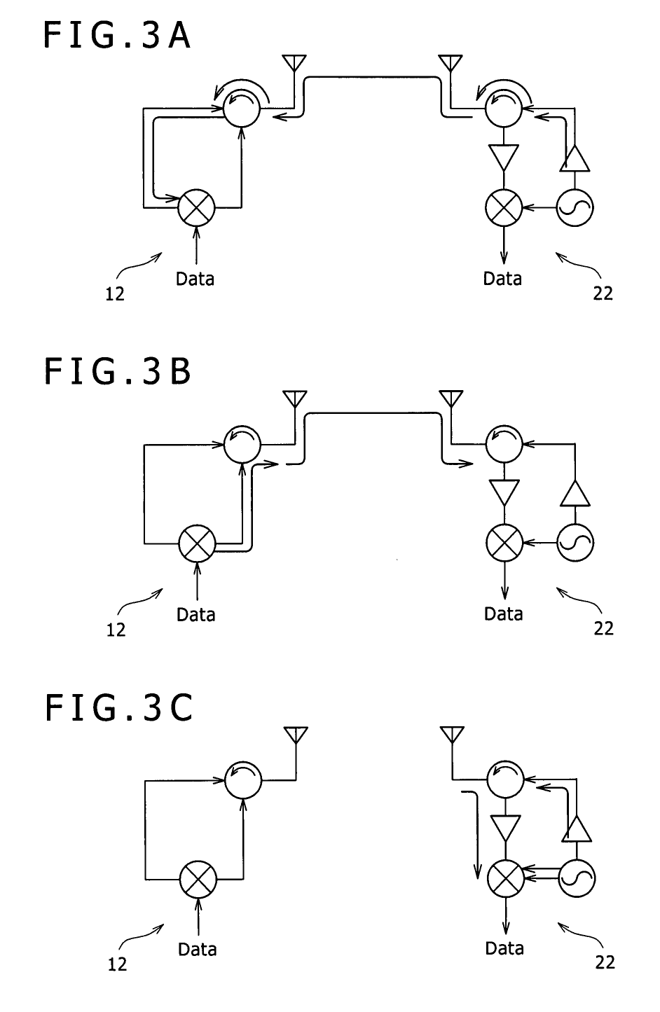

Next, signal flows in the reflected signal sending module 12 and the reflected signal receiving module 22 are explained by referring to FIG. 3.

FIG. 3A is a diagram showing a signal flow in a process to send an EHF or microwave band unmodulated carrier signal from the electronic instrument 20 to the remote control apparatus 10. In a process to send an EHF or microwave band unmodulated carrier signal from the electronic instrument 20 to the remote control apparatus 10 as shown in FIG. 3A, first of all, the oscillator 221 employed in the reflected signal receiving module 22 is turned on, being put in an oscillating state, in order to generate the unmodulated carrier signal, which is typically an EHF band single carrier having a typical frequency of 60 GHz. Then, the EHF band single carrier is supplied to the amplifier 225 for amplifying the carrier. Subsequently, the amplifier 225 supplies the amplified carrier to the antenna 223 by way of the circulator 224. Finally, the antenna 223 radiates the EHF band unmodulated carrier signal to the air.

The antenna 122 employed in the reflected signal sending module 12 receives the EHF band unmodulated carrier signal radiated by the antenna 223 and supplies the unmodulated carrier signal to the modulator 121 by way of the circulator 123. In order to amplify the unmodulated carrier signal by making use of an amplifier not shown in the figure, power supplies of the amplifier and the modulator 121 are turned on in a state of being interlocked with each other only during a process carried out by the modulator 121 to modulate the unmodulated carrier signal. In this way, consumption of electric power can be reduced.

As described earlier, the modulator 121 typically modulates the EHF band unmodulated carrier signal in accordance with data stored in the storage medium 14 as data to be sent to the electronic instrument 20 by adoption of a BPSK.

FIG. 3B is a diagram showing a signal flow in a process to send the modulated EHF band carrier signal from the remote control apparatus 10 to the electronic instrument 20 as a reflected signal. As shown in the figure, the modulator 121 supplies the modulated EHF band carrier signal to the antenna 122 by way of the circulator 123. The antenna 122 radiates the modulated EHF band carrier signal to the air as a reflected signal. The antenna 223 employed in the electronic instrument 20 receives the modulated EHF band carrier signal from the antenna 122. FIG. 3C is a diagram showing a signal flow in a process carried out by the electronic instrument 20 to receive the modulated EHF band carrier signal radiated by the remote control apparatus 10. As shown in the figure, the antenna 223 supplies the modulated EHF band carrier signal to the amplifier 226 by way of the circulator 224. The amplifier 226 amplifies the modulated EHF band carrier signal and supplies the amplified modulated EHF band carrier signal to the demodulator 222 for demodulating the amplified modulated EHF band carrier signal from time to time. Power supplies of the oscillator 221, the demodulator 222 as well as the amplifiers 225 and 226 are turned on in a state of being interlocked with each other only during a process carried out by the electronic instrument 20 to receive data from the remote control apparatus 10. In this way, consumption of electric power can be reduced.

In a communication making use of an EHF or microwave band carrier signal as described above, a carrier signal having a frequency determined in advance is exchanged between a pair of antennas. In such a communication, an unmodulated carrier signal generated by the electronic instrument 20 serving as the sender of the unmodulated carrier signal is modulated by the remote control apparatus 10 serving as a receiver of the unmodulated carrier signal. Thus, the communication does not raise problems such as deterioration of the S/N ratio and signal distortions. In other words, rather than execution of the communication along the time axis, the unmodulated carrier signal is modulated and reflected to the electronic instrument 20 concurrently with the sending of the unmodulated carrier signal from the electronic instrument 20 within a period of time. In addition, the remote control apparatus 10 is not put in an oscillating state to generate its own local signal, the role of which is played by the unmodulated carrier signal received from the electronic instrument 20 serving as an electronic instrument. That is to say, since it is the electronic instrument 20 that is put in an oscillating state to generate the unmodulated carrier signal, the power consumption of the remote control apparatus 10 can be reduced.

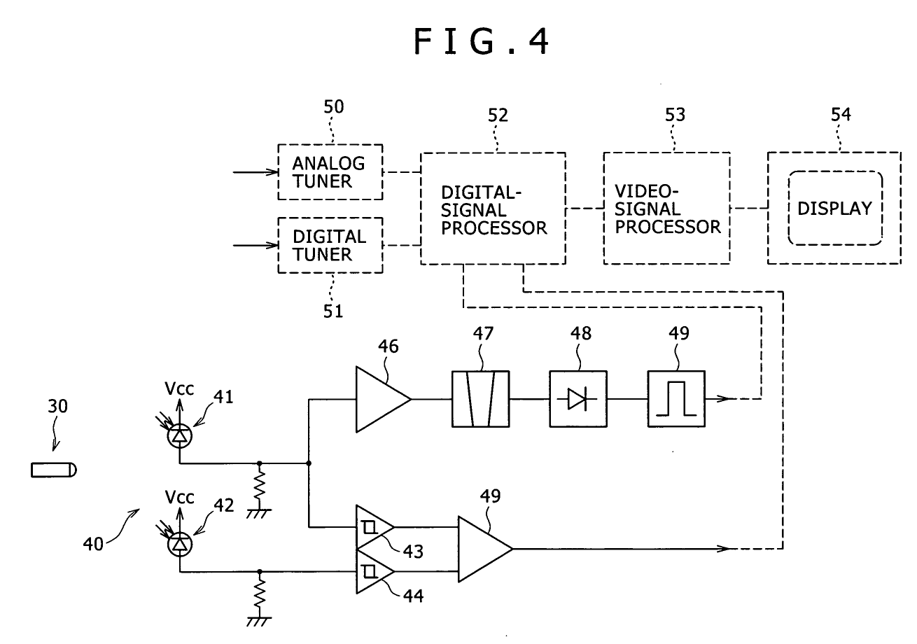

The following description explains a data transmission making use of an EHF band carrier signal as a typical concrete application of the embodiment of the present invention. FIG. 4 is a block diagram showing a remote control system employing a TV set 40 and a remote controller 30 for sending an infrared ray signal as a remote control signal to the TV set 40, which is remotely controlled by the remote controller 30.

The remote controller 30 sends an infrared ray signal, which is a remote control signal serving as a control command, to the TV set 40. Light receiving sections for receiving the infrared ray signal from the remote controller 30 as will be described later in detail are provided on the front face of the TV set 40. When giving a control command to the TV set 40 in order to control the TV set 40, the user sets the posture of the remote controller 30 in a direction toward the front face of the TV set 40, operating the remote controller 30 to send the command to the TV set 40. At that time, a path for exchanging an band carrier signal between the remote controller 30 and the TV set 40 is established.

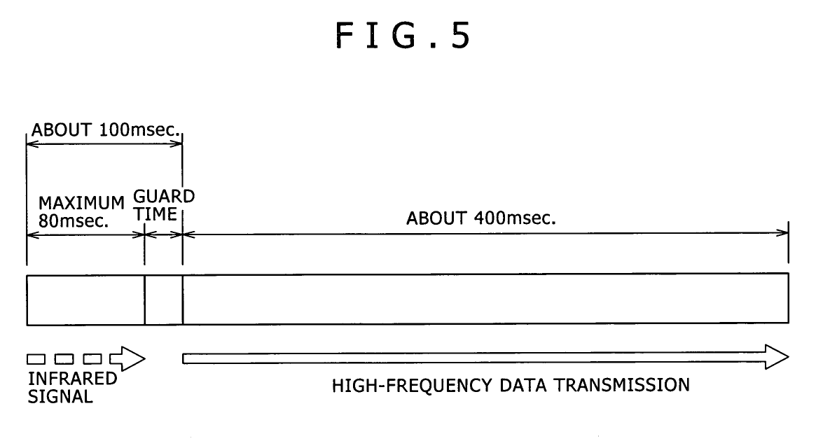

FIG. 5 is a diagram showing timings for sending an infrared ray signal from the remote controller 30 to the TV set 40 as a control command and sending an EHF band unmodulated carrier signal from the TV set 40 to the remote controller 30. The control command is a train of infrared ray ON/OFF pulses. The length of the pulse train is a very small value not exceeding a maximum of about 80 msec. A sending time of the infrared ray signal is defined as the sum of the length of the pulse train and a guard time. Thus, a maximum sending time of the infrared ray signal is about 100 msec. The guard time is a period demanded by the TV set 40 to get a variety of blocks thereof stabilized after the power supplies of the blocks are turned on. The guard time may also include a margin demanded for operating the remote control system, which has turned off the blocks after a period corresponding to the margin has lapsed since an operation to end operations of the blocks.

In addition, the user typically keeps the remote controller 30 in a posture set in a direction toward the front face of the TV set 40 because the remote controller 30 should be waited for a late response given by the TV set 40 to a control command given to the TV set 40 or because the user needs to give a next control command to the TV set 40 in some cases. An example of the response of the TV set 40 to a control command such as a command to change the channel of a display appearing on the screen of the TV set 40 is an operation carried out by the TV set 40 to change the channel. In addition, the use of the remote controller 30 to control the TV set 40 separated away from the remote controller 30 by an obstacle such as a human being is hardly conceivable. It is thus understood that a connection between the remote controller 30 and the TV set 40 is difficult to establish when an obstacle such as a human being is passing through the space between the remote controller 30 and the TV set 40. Let us assume for example that the toleratable period of time in which the user is keeping the remote controller 30 in a posture set in a direction toward the TV set 40 is 0.5 seconds taking a blocking period due to an obstacle into consideration. In this case, the period of time that can be used to transfer an EHF band carrier signal is 400 msec., which is obtained by subtracting the blocking period from the 0.5 seconds.

The reader is suggested to refer back to FIG. 4. As shown in the figure, the TV set 40 includes a first light receiving section 41, a second light receiving section 42, an integrator 43, another integrator 44, a comparator 45, an amplifier 46, a BPF (Band Pass Filter) 47, a detector 48 and a waveform reshaping section 49. The integrator 43 is a section for integrating a current signal output by the first light receiving section 41 as a signal representing an infrared ray signal received by the first light receiving section 41 from the remote controller 30. By the same token, the integrator 44 is a section for integrating a current signal output by the second light receiving section 42 as a signal representing an infrared ray signal received by the second light receiving section 42 from the remote controller 30. The comparator 45 is a section for comparing the level of an integrated signal output by the integrator 43 as a signal representing the infrared ray signal received by the first light receiving section 41 with the level of an integrated signal output by the integrator 44 as a signal representing the infrared ray signal received by the second light receiving section 42. The amplifier 46 is a section for amplifying a current signal output by the first light receiving section 41 as a signal representing the infrared ray signal received by the first light receiving section 41. The BPF 47 is a filter for passing signal components generated by the amplifier 46 as components each having a frequency in a specific range. The detector 48 is a section for fetching a control command from such signal components representing the infrared ray signal received from the remote controller 30. The waveform reshaping section 49 is a section for reshaping the waveform of the control command fetched by the detector 48.

In addition, the TV set 40 also employs ordinary functional blocks such as an analog tuner 50, a digital tuner 51, a digital-signal processor 52, a video-signal processor 53 and a display section 54 as shown in the figure.

The amplifier 46 amplifies an infrared ray signal received by the first light receiving section 41 from the remote controller 30 and supplies the amplified signal to the waveform reshaping section 49 for reshaping the waveform of a detected control command by way of the BPF 47 and the detector 48. The waveform reshaping section 49 reshapes the waveform of a control command detected by the detector 48 from signal components output by the BPF 47 to the digital-signal processor 52.

The first light receiving section 41 and the second light receiving section 42 are each a photodiode for generating the aforementioned current signal according to pulses of an infrared ray signal received from the remote controller 30. Since the anode of the photodiode serving as the first light receiving section 41 is connected to the ground by a resistor, a train of electrical voltage pulses proportional to the magnitude of each of the infrared ray signal pulses appears on the anode. By the same token, since the anode of the photodiode serving as the second light receiving section 42 is connected to the ground by a resistor, a train of electrical voltage pulses proportional to the magnitude of each of the infrared ray signal pulses appears on the anode. Because a train of electrical voltage pulses is difficult to deal with, the train of electrical voltage pulses generated by the first light receiving section 41 is supplied to the integrator 43 for generating a voltage level smoothed to a certain degree whereas the train of electrical voltage pulses generated by the second light receiving section 42 is supplied to the integrator 44 for generating a voltage level smoothed to a certain degree. The comparator 45 compares the voltage level generated by the integrator 43 with the voltage level generated by the integrator 44. The comparator 45 supplies the result of the comparison to the digital-signal processor 52, which has a function similar to that of the control module 23 employed in the electronic instrument 20 as shown in FIG. 1. As described earlier, the control module 23 is a section for controlling a process carried out by the reflected signal receiving module 22 employed in the electronic instrument 20 as shown in FIG. 1 to send an EHF or microwave band unmodulated carrier signal to the remote control apparatus 10.

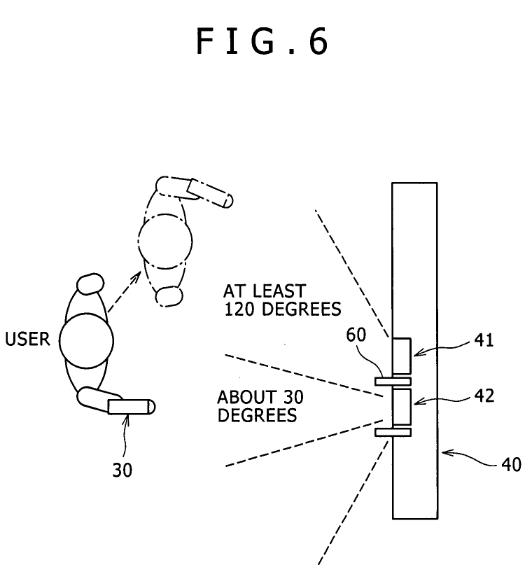

FIG. 6 is a diagram showing a typical installation layout of the first light receiving section 41 and the second light receiving section 42, which are provided on the front face of the TV set 40. The layout is explained by referring to the figure as follows. In the typical configuration shown in FIG. 6, the first light receiving section 41 has an ordinary directivity characteristic range of 120 degrees whereas the second light receiving section 42 has a sharp directivity characteristic range of 30 degrees. The directivity characteristic range of a light receiving section is defined as an angle, infrared rays arriving from a source located in which can be detected by the light receiving section. In order to implement the directivity characteristic range of the second light receiving section 42 as a sharp angle, the second light receiving section 42 is provided with shading plates 60 for preventing infrared rays arriving from a source located outside the angle from hitting the second light receiving section 42.

If the output of the first light receiving section 41 has about the same magnitude as the output of the second light receiving section 42, the infrared ray signal can be determined to be a signal generated by the remote controller 30 located in the 30-degree directivity characteristic range of the second light receiving section 42, which has a sharp directivity characteristic. Such a location of the remote controller 30 is desirable because, in conjunction with the TV set 40, the remote controller 30 forms a transmission line serving as the path of an EHF band carrier exchanged between the remote controller 30 and the TV set 40. If the remote controller 30 is located in a directivity characteristic range seen by the TV set 40 as angle in the range 30 degrees to 120 degrees, on the other hand, the integrator 44 provided for the second light receiving section 42 generates no output for an infrared ray signal received from the remote controller 30. In this case, the condition for establishing a transmission line serving as the path of an EHF band carrier exchanged between the remote controller 30 and the TV set 40 is considered to be a strict condition.

By increasing the number of such light receiving sections, the TV set 40 is capable of determining an angle, in which the remote controller 30 is located, with a higher degree of resolution.

It is to be noted that the result of determination as to whether or not a transmission path of an EHF band carrier signal can be established can also be reported to the user. Typically, a message stating: “A data transmission is not possible.” or the like can be displayed on the display section 54 or, for example, a LED (Light Emitting Diode) provided on the TV set 40 is turned on to indicate that a data transmission is possible. As an alternative, it is possible to provide a configuration in which a state reporting section is employed in the remote controller 30 as a section configured to notify the user that the remote controller 30 has not received an EHF band unmodulated carrier signal from the TV set 40.

In addition, in the configuration described above, the shading plates 60 are used for assuring the sharp directivity characteristic of the second light receiving section 42. However, techniques for assuring the sharp directivity characteristic of the second light receiving section 42 are by no means limited to the shading plates 60. For example, the characteristic of an optical lens employed in the infrared ray photodiode unit can be changed to make the light receiving directivity characteristic sharp.

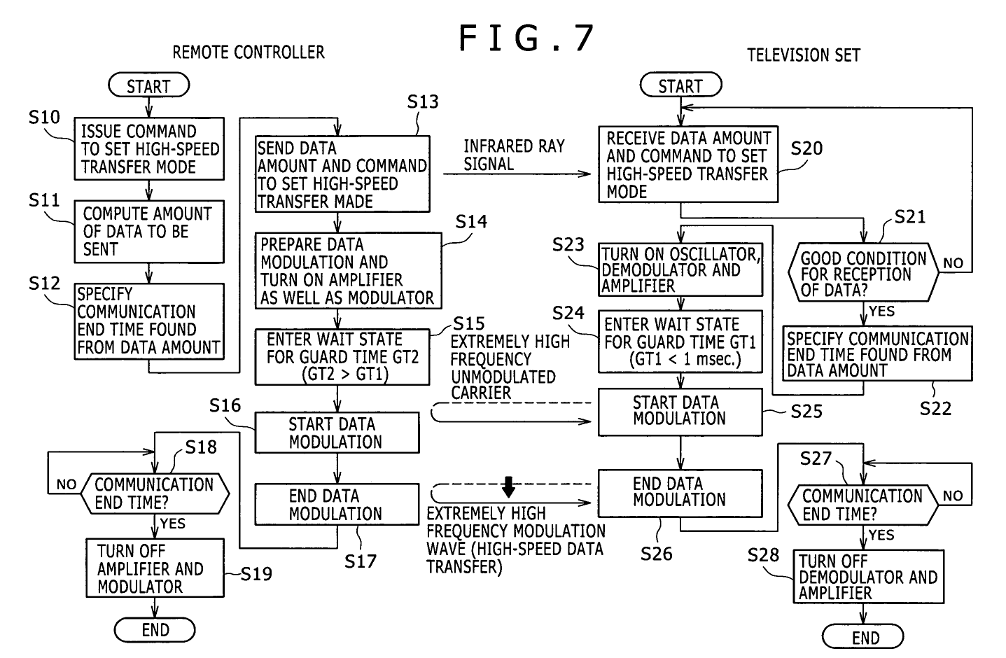

Next, the operations of the remote controller 30 and the TV set 40 are explained by referring to a flowchart shown in FIG. 7.

The operation of the remote controller 30 is described by referring to the remote control apparatus 10 shown in FIG. 1 as an apparatus corresponding to the remote controller 30 as follows. For example, the user operates the remote controller 30 by pressing a high-speed data transfer switch in order to enter a control command for setting a high-speed data transfer mode. In this case, the remote controller 30 enters a high-speed data transfer mode at a step S10. Then, at the next step S11, the control module 13 employed in the remote control apparatus 10 computes the amount of data stored in the storage medium 14 as data associated with the command entered by the user. The amount of data can be the number of bits of the data or the number of bytes of the data in accordance with the command entered by the user. The computed amount of data is the amount of data to be sent to the TV set 40. Then, at the next step S12, the control module 13 finds a communication period from the amount of data and a communication bit rate, specifying a communication end time. For example, if the amount of data is 10 megabytes or 80 megabits and the communication bit rate is 160 Mbps, the communication period is 80 megabits/160 Mbps=0.5 seconds. That is to say, it takes 0.5 seconds to transmit the data to the TV set 40. The communication end time is found from the communication period by further adding a guard time cited before to the communication period.

Then, at the next step S13, the remote control signal sending module 11 sends the data amount computed in the process carried out at the step S11 and the control command to set high-speed data transfer mode to the TV set 40.

Subsequently, at the next step S14, the reflected signal sending module 12 turns on the modulator 121 employed therein as shown in FIG. 2 and an amplifier not shown in the figure. Then, at the next step S15, the remote control apparatus 10 enters a wait state for a guard time GT2.

After the lapse of the guard time GT2, the reflected signal sending module 12 receives an EHF band unmodulated carrier signal from the TV set 40 and starts a process to modulate the unmodulated carrier signal in the modulator 121 at a step S16. The EHF band unmodulated carrier signal modulated by the modulator 121 is sent to the TV set 40 by way of the circulator 123 and the antenna 122 as a reflected signal.

Then, at the next step S17, the process to modulate the unmodulated carrier signal in the modulator 121 is ended and the remote control apparatus 10 enters a wait state for a guard time. Subsequently, the flow of the operation of the remote control apparatus 10 goes on to the next step S18 in order to produce a result of determination as to whether or not the communication end time specified in the process carried out at the step S12 has been reached. If the result of the determination indicates that the communication end time has been reached, the flow of the operation of the remote control apparatus 10 goes on to step S19, at which the amplifier and the modulator 122 are turned off.

Next, the operation of the TV set 40 is described by referring to the electronic instrument 20 shown in FIG. 1 as an instrument corresponding to the TV set 40 as follows. First of all, at a step S20, the remote control signal receiving module 21 receives an infrared ray signal, which conveys the control command to set a high-speed data transfer mode and the amount of data to be sent from the remote control apparatus 10 to the electronic instrument 20, from the remote control apparatus 10.

Then, at the next step S21, the control module 23 examines the state of reception of the infrared ray signal received by the remote control signal receiving module 21 in order to produce a result of determination as to whether or not the state of reception of the received signal suggests a good condition for reception of the data from the remote control apparatus 10. Concretely, by referring to FIG. 4, the comparator 45 compares the voltage level generated by the integrator 43 as a level representing electrical pulses generated by the first light receiving section 41 with the voltage level generated by the integrator 44 as a level representing electrical pulses generated by the second light receiving section 42. The control module 23 supplies the result of the comparison to the digital-signal processor 52, which then makes use of the result of the determination to produce a result of determination as to whether or not the remote control apparatus 10 is located within a predetermined angle, that is, whether or not the data can be received from the remote control apparatus 10 by making use of an EHF band carrier signal.

If the determination result produced in the process carried out at the step S21 indicates that the state of reception of the received signal suggests a good condition for reception of the data from the remote control apparatus 10, the flow of the operation of the TV set 40 goes on to a step S22. At the step S22, a communication end time is found from the data amount computed in the process carried out at the step S20 as the amount of data to be sent as well as the communication bit rate, and specified as the time to end the communication.

Then, at the next step S23, the reflected signal receiving module 22 turns on the oscillator 221, the demodulator 222 as well as the amplifiers 225 and 226. The oscillator 221, the demodulator 222 as well as the amplifiers 225 and 226 are employed in the reflected signal receiving module 22 as shown in FIG. 2. Then, at the next step S24, the electronic instrument 20 enters a wait state for a guard time GT1. A guard time GT1 shorter than 1 msec. is desirable because, during the guard time GT1, the user is keeping the remote controller 30 in a posture set in a direction toward the TV set 40. It is also desirable to have a guard time GT1 shorter than the aforementioned guard time GT2 set for the remote controller 30.

After the lapse of the guard time GT1, the oscillator 221 employed in the reflected signal receiving module 22 as shown in FIG. 2 generates an EHF band unmodulated carrier signal and sends the unmodulated carrier signal to the remote controller 30 by way of the amplifier 225, the circulator 224 and the antenna 223. Then, the antenna 223 receives a reflected signal, which has been obtained as a result of a process carried out by the remote controller 30 to modulate the EHF band unmodulated carrier signal, from the remote controller 30. The antenna 223 supplies the reflected signal to the demodulator 222 by way of the circulator 224 and the amplifier 226. Then, at a step S25, the demodulator 222 starts a process to demodulate the reflected signal.

Then, at the next step S26, the process to demodulate the reflected signal is ended and the electronic instrument 20 enters a wait state for a guard time. Subsequently, the flow of the operation of the electronic instrument 20 goes on to the next step S27 in order to produce a result of determination as to whether or not the communication end time specified in the process carried out at the step S22 has been reached. If the result of the determination indicates that the communication end time has been reached, the flow of the operation of the remote control apparatus 10 goes on to step S28, at which the modulator 222 as well as the amplifiers 225 and 226 are turned off.

As described above, data is sent from the remote controller 30 to the TV set 40 only if a path of transmission of an EHF band carrier signal is established between the remote controller 30 to the TV set 40 when, for example, the user operates the remote controller 30 by pressing a high-speed data transfer switch in order to enter a control command for setting a high-speed data transfer mode. Thus, data of a large amount can be transferred from the remote controller 30 to the TV set 40 with a high degree of reliability. Let us assume for example that a JPEG (Joint Photographic Experts Group) picture taken by making use of a digital camera is transferred at a data transfer rate of 160 Mbps. In this case, the amount of data of a very fine JPEG picture composed of 5,000,000 pixels is about 2.5 megabytes or 20 megabits. Thus, it takes 0.125 seconds to transfer such a picture.

In addition, the oscillator 221 employed in the electronic instrument 20 serving as the TV set 40 generates the EHF band unmodulated carrier signal and, thus, the remote controller 30 does not have to generate such an unmodulated carrier signal. As a result, the power consumption of the remote controller 30 can be suppressed. Let us assume for example that the amount of power consumed by internal circuits employed in the remote controller 30 during a data transfer according to the embodiment is 100 mW excluding the power consumption demanded by other ordinary functions of the remote controller 30. If the total data transfer time is 10 seconds per day, assuming that the remote controller 30 is used for 360 days a year, the total data transfer time is 360×10=3600 seconds (or 60 minutes=1 hour) per year. Thus, the total power consumption of the remote controller 30 is 100 mWh per year. Accordingly, assuming that the useful energy capacity of a size AA battery is in the range 1,500 to 2,000 mWh, the total power consumption of the remote controller 30 does not exceed 10% of the useful energy capacity of a size AA battery. That is to say, in accordance with the above calculations, the energy of the battery almost remains the same in one year.

It is to be noted that, in the embodiment described above, a communication period is computed from the amount of data to be sent from the remote control apparatus 10 to the electronic instrument 20 as well as a data transfer rate at which the data is sent and, when a communication end time is reached upon the lapse of the communication period, the modulator employed in the remote control apparatus 10 and the demodulator employed in the electronic instrument 20 are turned off. However, implementations of the present invention are by no means limited to this embodiment. For example, it is possible to provide a configuration in which the amount of data actually sent by the remote control apparatus 10 to the electronic instrument 20 is actually measured and, as the measured amount of data becomes equal to the computed amount of data, the modulator employed in the remote control apparatus 10 is turned off. By the same token, the amount of data actually received by the electronic instrument 20 from the remote control apparatus 10 is actually measured and, as the measured amount of data becomes equal to the computed amount of data, the demodulator employed in the electronic instrument 20 is turned off. In addition, it is also possible to provide a configuration in which the modulator employed in the remote control apparatus 10 is turned off as a predetermined period of time lapses even though the process carried out by the remote control apparatus 10 to send data from the remote control apparatus 10 to the electronic instrument 20 has not been completed and, by the same token, the demodulator employed in the electronic instrument 20 is turned off as a predetermined period of time lapses even though the process carried out by the electronic instrument 20 to receive data from the remote control apparatus 10 has not been completed.

It should be understood by those skilled in the art that various modifications, combinations, sub-combinations and alterations may occur depending on design requirements and other factors insofar as they are within the scope of the appended claims or the equivalents thereof.

What is claimed is:

1. A radio transmission system, comprising:
a remote control apparatus; and
an electronic instrument configured to carry out radio transmissions with and remotely controlled by said remote control apparatus;
said remote control apparatus including
a remote control signal sending section configured to send a remote control signal to said electronic instrument, and
a reflected signal sending section configured to receive a microwave unmodulated carrier signal in an extremely high frequency band from said electronic instrument after or during sending of a remote control signal and modulate and send the unmodulated carrier signal as a reflected signal to said electronic instrument,
said electronic instrument including
a remote control signal receiving section configured to receive a remote control signal from said remote control apparatus,
a reflected signal receiving section configured to send a microwave unmodulated carrier signal in an extremely high frequency band to said remote control apparatus and receive a reflected signal modulated from the unmodulated carrier signal from said remote control apparatus, and
a control section configured to control determination as to whether or not the unmodulated carrier signal should be sent to said remote control apparatus in response to a state of reception of the remote control signal.

2. The radio transmission system according to claim 1, wherein
said remote control signal receiving section includes a plurality of light receiving sections; and
said control section identifies the position from which the remote control signal is sent in accordance with levels of light received by said light receiving sections.

3. The radio transmission system according to claim 1, wherein
said reflected signal receiving section includes an oscillator for generating the unmodulated carrier signal; a demodulator for demodulating the reflected signal; an antenna for sending the unmodulated carrier signal and receiving the reflected signal; and a circulator to which said demodulator, oscillator and antenna are connected; and
said reflected signal sending section includes a modulator for modulating the unmodulated carrier signal to form the reflected signal; an antenna for receiving the unmodulated carrier signal and sending the reflected signal; and a circulator to which said modulator and said antenna are connected.

4. The radio transmission system according to claim 1, wherein
said remote control apparatus further includes a storage medium accepting device configured to removably accept a storage medium used for storing data; and
said reflected signal sending section transfers the data read out from the storage medium through said storage medium accepting device as the reflected signal by burst transfer.

5. The radio transmission system according to claim 1, wherein said electronic instrument further includes a reporting section configured to report a state of reception of the remote control signal.

6. A remote control apparatus, comprising:
a remote control signal sending section configured to send a remote control signal; and
a reflected signal sending section configured to receive a microwave unmodulated carrier signal in an extremely high frequency band after or during sending of the remote control signal and modulate and send the carrier signal as a reflected signal.

7. The remote control apparatus according to claim 6, wherein said reflected signal sending section includes a modulator for modulating the unmodulated carrier signal to form the reflected signal; an antenna for receiving the unmodulated carrier signal and sending the reflected signal; and a circulator to which said modulator and said antenna are connected.

8. The remote control apparatus according to claim 6, wherein
said remote control apparatus further includes a storage medium accepting device configured to removably accept a storage medium used for storing data, and
said reflected signal sending section transfers the data read out from the storage medium through said accepting device as the reflected signal by burst transfer.

9. An electronic instrument, comprising:
a remote control signal receiving section configured to receive a remote control signal;
a reflected signal receiving section configured to send a microwave unmodulated carrier signal in an extremely high frequency band and receive a reflected signal modulated from the unmodulated carrier signal; and
a control section configured to control determination as to whether or not the unmodulated carrier signal should be sent in response to a state of reception of the remote control signal.

10. The electronic instrument according to claim 9, wherein
said remote control signal receiving section includes a plurality of light receiving sections; and
said control section identifies the position from which the remote control signal is sent in accordance with levels of light received by said light receiving sections.

11. The electronic instrument according to claim 9, wherein said reflected signal receiving section includes an oscillator for oscillating the unmodulated carrier signal; a demodulator for demodulating the reflected signal; an antenna for sending the unmodulated carrier signal and receiving the reflected signal; and a circulator to which said demodulator and antenna are connected.

12. The electronic instrument according to claim 9, further comprising a reporting section configured to report a state of reception of the remote control signal.

13. A radio transmission method for carrying out radio transmissions between a remote control apparatus and an electronic instrument which is remotely controlled by the remote control apparatus, the radio transmission method comprising the steps of:
receiving a remote control signal, carried out by the electronic instrument, of receiving a remote control signal sent from the remote control apparatus;
sending an unmodulated carrier, carried out by the electronic instrument, of sending a microwave unmodulated carrier signal in an extremely high frequency band in response to a state of reception of the remote control signal received at the remote control signal receiving step;
sending a reflected signal, executed by the remote control apparatus, of receiving the unmodulated carrier signal sent at the modulated carrier sending signal and modulating and sending the unmodulated carrier signal as a reflected signal to the electronic instrument; and
demodulating a reflected signal, carried out by the electronic instrument, of receiving and demodulating the reflected signal sent from the remote control apparatus at the reflected signal sending step.
